(19) United States
(12) Patent Application Publication
(10) Pub. No.: US 2025/0383665 A1
(43) Pub. Date: Dec. 18, 2025

(54) AUTONOMOUS CONTROL SYSTEM

(71) Applicant: HITACHI, LTD., Tokyo (JP)

(72) Inventors: Shinji ISHIHARA, Tokyo (JP); Ryu NARIKAWA, Tokyo (JP); Masaki KANAI, Tokyo (JP); Kazuya SUGIMOTO, Tokyo (JP); Tadashi KOTANI, Tokyo (JP); Yuri EISAKI, Tokyo (JP)

(21) Appl. No.: 18/878,192

(22) PCT Filed: Jul. 5, 2023
(86) PCT No.: PCT/JP2023/025029

§ 371 Date: Dec. 23, 2024

(30) Foreign Application Priority Data
Aug. 24, 2022 (JP) 2022-133333

(51) Int. Cl. G05D 1/617; G05D 101/10

(52) U.S. Cl. CPC G05D 1/617; G05D 2101/10

(57) ABSTRACT

This autonomous control system: calculates the position of an object to be controlled (first object); identifies an attribute of an object not to be controlled (second object); calculates the position of the second object; evaluates the degree of deviation of the movement trajectory of the second object from a predicted movement trajectory of the second object corresponding to the attribute of the second object; determines a safety standard related to the action of the first object, on the basis of the attribute of the second object and the degree of deviation from the predicted movement trajectory; and, on the basis of the position of the first object, the position of the second object, and the safety standard, corrects the action of the first object such that the first object becomes less likely to approach the second object as the safety standard becomes higher.

### TECHNICAL FIELD

This invention relates to an autonomous control system.

### BACKGROUND ART

In recent years, the development of autonomous driving technology has progressed in order to reduce traffic accidents and traffic congestion. Autonomous driving technology is also attracting high expectations in the logistics industry, where labor shortages are serious. Autonomous driving technology is being deployed in a wide range of applications, including trucks that pick up and deliver goods on public roads, but also forklifts used to collect and store goods in factories and warehouses, transport robots called automatic guided vehicles (AGVs) and autonomous mobile robot (AMRs), and in-process transport vehicles.

With the exception of large, fully automated logistics warehouses, autonomous driving technology is used in environments where people (mainly pedestrians) and non-autonomous vehicles (for example, forklifts operated by workers) coexist. Therefore, autonomous vehicles must have safety functions to prevent contact with pedestrians or non-autonomous vehicles.

In general, to achieve such safety functions, the trajectory on which pedestrians and non-autonomous vehicles are likely to move is predicted, and an autonomous vehicle is controlled so that a host vehicle does not come into contact with the predicted trajectory.

Non-autonomous vehicles are mainly governed by nonholonomic constraints on their motion and therefore cannot move directly sideways or change direction suddenly, whereas pedestrians can move freely in a variety of directions, making it difficult to calculate predicted trajectories.

To address these problems, Patent Literature 1 presents a driving assistance system that assists in safe driving in environments including pedestrians, which are difficult to predict, by having the function of calculating the probability that a mobile object is on the planned route of an autonomous vehicle (in the patent literature, predictive information) using recorded past trajectory information of mobile objects (including pedestrians).

### CITATION LIST

### Patent Literature

Patent Literature 1: Japanese Unexamined Patent Application Publication No. 2016-53846

### SUMMARY OF INVENTION

### Technical Problem

In Patent Literature 1, in order to generate predictive information of a mobile object, a large amount of information recording the trajectories of mobile objects in the past is required. Therefore, if this record (database) is insufficient, appropriate predictive information cannot be provided. And if appropriate predictive information is not available, it is expected to be difficult to provide sufficient safe driving functions.

The present invention has been devised to address the above problems and aims to provide an autonomous control system capable of driving a vehicle efficiently and safely even when it is difficult to predict the behavior of surrounding mobile objects.

### Solution to Problem

According to one aspect of the present invention, an autonomous control system controls, in an area where a controlled object that is a behavior-controllable mobile object and a non-controlled object that is a behavior-uncontrollable mobile object are mixed, behavior of the controlled object so that the controlled object and the non-controlled object do not come into contact with each other, and the autonomous control system includes: a controlled object position calculation unit that calculates a position of the controlled object; an object identification unit that identifies an attribute of the non-controlled object; a non-controlled object position calculation unit that calculates a position of the non-controlled object; a trajectory deviation evaluation unit that evaluates a degree of deviation of a movement trajectory of the non-controlled object calculated by the non-controlled object position calculation unit from a predicted movement trajectory of the non-controlled object corresponding to the attribute of the non-controlled object identified by the object identification unit; a safety level determination unit that determines a safety level for the behavior of the controlled object on a basis of the attribute of the non-controlled object identified by the object identification unit and the degree of deviation from the predicted movement trajectory evaluated by the trajectory deviation evaluation unit; and a behavior correction unit that corrects the behavior of the controlled object such that the higher the safety level, the less the controlled object approaches the non-controlled object on the basis of the position of the controlled object calculated by the controlled object position calculation unit, the position of the non-controlled object calculated by the non-controlled object position calculation unit, and the safety level determined by the safety level determination unit.

### Advantageous Effects of Invention

According to the present invention, it is possible to provide an autonomous control system capable of driving a vehicle efficiently and safely even when it is difficult to predict the behavior of surrounding mobile objects.

### BRIEF DESCRIPTION OF DRAWINGS

FIG. 1 is a functional block diagram of an autonomous control system according to a first embodiment of the present invention.

FIG. 2 is a schematic diagram showing a vehicle to be controlled and a pedestrian not to be controlled by the autonomous control system.

FIG. 3 is a functional block diagram of a trajectory deviation evaluation unit.

FIG. 4 is a schematic diagram showing an example of a predicted movement trajectory calculated by a predicted trajectory calculation unit.

FIG. 5 is a schematic diagram showing examples of a predicted trajectory and an actual trajectory.

FIG. 6 illustrates a method for determining a safety level by a safety level determination unit according to the first embodiment.

FIG. 7 is a schematic diagram illustrating motion control of a four-wheeled vehicle.

FIG. 8 is a schematic diagram showing the positional relationship between a controlled object and a non-controlled object.

FIG. 9 is a flowchart showing an example of the flow of processing executed by a controller of the autonomous control system.

FIG. 10 is a schematic diagram showing a logistics warehouse to which an autonomous control system according to a second embodiment is applied.

FIG. 11 is a schematic diagram illustrating motion control of a transport robot.

FIG. 12 illustrates a method for determining a safety level by a safety level determination unit according to the second embodiment.

FIG. 13 shows an example of the relationship between a function h(ε(k)) and a function ε(k).

FIG. 14 shows the configuration of an autonomous control system according to a first modification, and shows a vehicle as a mobile object to be controlled and a pedestrian as a mobile object not to be controlled.

FIG. 15 illustrates a method for determining a safety level and the priority of a host vehicle by a safety level determination unit according to a second modification.

### DESCRIPTION OF EMBODIMENTS

### First Embodiment

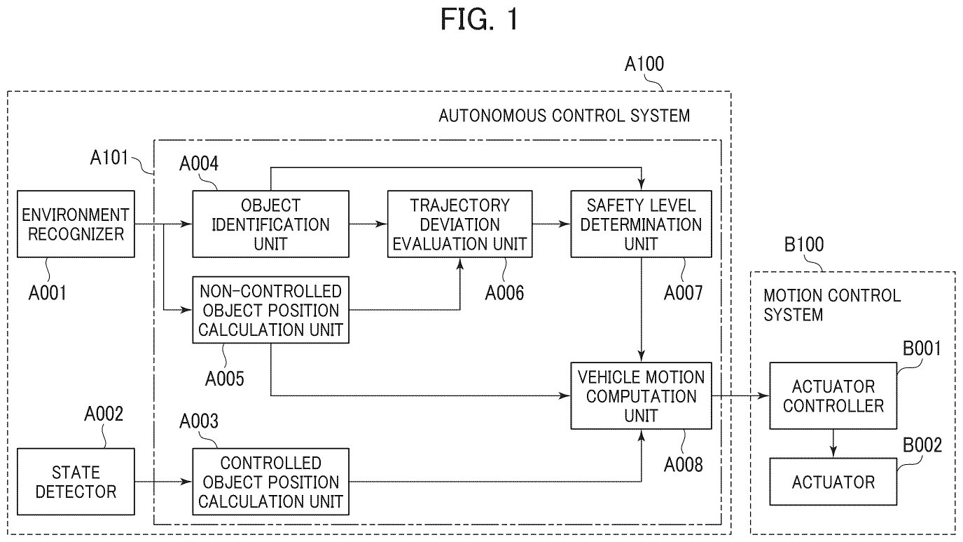

FIG. 1 is a functional block diagram of an autonomous control system according to a first embodiment of the present invention. An autonomous control system A100 and a motion control system B100 shown in FIG. 1 are mounted in a vehicle to be controlled. In an area where controlled and non-controlled objects coexist, the autonomous control system A100 collects surrounding information of a vehicle to be controlled, and causes the motion control system B100 to control the motion (behavior) of the vehicle to be controlled, in such a manner that mobile objects (for example, pedestrians, other vehicles, or the like) other than the vehicle to be controlled do not come into contact with the controlled object. In FIG. 1, illustration of parts that are not directly related to the functions of the autonomous control system A100 according to the present embodiment is omitted.

Note that the vehicle to be controlled are not limited to a fully autonomous vehicle. For example, the vehicle may be a semi-autonomous vehicle that is normally driven by a driver, and in which the autonomous control system A100 can intervene to perform control such as deceleration or stopping only in an emergency. Furthermore, the vehicle to be controlled may be a single vehicle traveling on a general public road, or may be a vehicle (robot) traveling within a logistics warehouse.

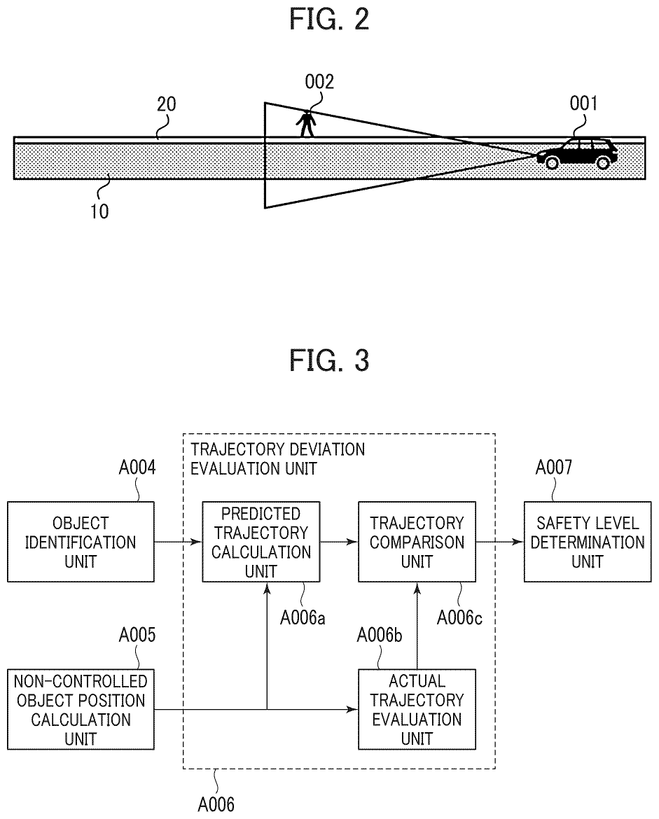

FIG. 2 is a schematic diagram showing a vehicle 001, which is a mobile object to be controlled, and a pedestrian 002, which is a mobile object not to be controlled. In the following, a case where the vehicle 001 traveling on a roadway 10 is an object to be controlled by the autonomous control system A100 and a non-controlled object is the pedestrian 002 walking on a sidewalk 20 will be described as a main example. That is, the vehicle 001 is a mobile object, the behavior of which can be controlled by the autonomous control system A100, and the pedestrian 002 is a mobile object, the behavior of which cannot be controlled by the autonomous control system A100. Note that, for ease of explanation, a situation is shown in which there is one controlled object and one non-controlled object, but the present invention can also be used in cases where there are a plurality of both controlled objects and non-controlled objects.

As shown in FIG. 1, the motion control system B100 includes an actuator controller B001 and an actuator B002. The actuator controller B001 controls the actuator B002 according to instructions from the autonomous control system A100. The actuator B002 is connected to, for example, the steering, accelerator, brake, or the like of the vehicle.

As shown in FIG. 1, the autonomous control system A100 includes an environment recognizer A001, a state detector A002, controlled object position calculation unit A003, an object identification unit A004, a non-controlled object position calculation unit A005, a trajectory deviation evaluation unit A006, a safety level determination unit A007, and a vehicle motion computation unit A008. The controlled object position calculation unit A003, the object identification unit A004, the non-controlled object position calculation unit A005, the trajectory deviation evaluation unit A006, the safety level determination unit A007, and the vehicle motion computation unit A008 are functions implemented by a controller A101.

The controller A101 is constituted by a computer including, for example, a processing device such as a central processing unit (CPU), a read only memory (ROM), a nonvolatile memory such as a flash memory, a volatile memory called a random access memory (RAM), an input/output interface, and other peripheral circuits. These pieces of hardware work together to run software and achieve multiple functions. Note that the controller A101 may be constituted by one computer or multiple computers.

The nonvolatile memory stores programs that can execute various computations and data such as threshold values. That is, the nonvolatile memory is a storage medium (storage device) from which the programs for implementing the functions of the present embodiment can be read. The volatile memory is a storage medium (storage device) that temporarily stores the computation results by the processing device and signals input from the input/output interface. The processing device is a device that expands a program stored in the nonvolatile memory into a volatile memory for computation and execution, and performs predetermined computation processing on data taken from the input/output interface, the nonvolatile memory, and the volatile memory in accordance with the program.

Note that the autonomous control system A100 does not need to be mounted on the controlled object (that is, the vehicle 001). As in a second embodiment described later, if the area in which the controlled object moves is limited, it is also possible to provide a computing function to a server capable of communicating with that area.

The environment recognizer A001 acquires environmental information representing the surrounding state of the controlled object. The environment recognizer A001 is, for example, an external recognition sensor such as a light detection and ranging (LiDAR) sensor, a stereo camera, or a millimeter wave radar mounted in the controlled object.

The state detector A002 acquires vehicle information (such as position, direction, and speed) that represents the state of the controlled object. The state detector A002 is, for example, a sensor such as a global navigation satellite system (GNSS) receiver that acquires positional information of the controlled object, or an inertial measurement unit (IMU) that acquires the acceleration and angular velocity of the controlled object.

Note that the environment recognizer A001 and the state detector A002 are not necessarily separate sensors. For example, a LiDAR sensor mounted in the controlled object functions as both the environment recognizer A001 and the state detector A002.

The controlled object position calculation unit A003 integrates the vehicle information acquired by the state detector A002 and calculates the position of the controlled object. For example, if the state detector A002 is a LiDAR, the controlled object position calculation unit A003 estimates the position of the controlled object using the well-known simultaneous localization and mapping (SLAM) technology. Furthermore, if the state detector A002 is a GNSS receiver and IMU, the controlled object position calculation unit A003 calculates the position of the controlled object by supplementing the update period of the positional information output from the GNSS receiver with the IMU using the well-known sensor fusion technology.

The object identification unit A004 identifies the attributes of non-controlled objects existing around the controlled object from the environmental information acquired by the environment recognizer A001 using the well-known image recognition technology or Semantic SLAM technology.

Note that the environment recognizer A001 and the object identification unit A004 may be integrated. For example, stereo cameras and millimeter wave radars can sometimes have the ability to identify mobile objects. In this case, there is no need to explicitly divide the environment recognizer A001 and the object identification unit A004.

The object identification unit A004 identifies characteristics related to the movement of mobile objects, such as pedestrians and bicycles, as attributes of non-controlled objects. Here, the characteristics related to movement refer to the equation of motion governing the dynamic characteristics of the mobile object and the maximum value of the moving speed. A pedestrian can move freely on a two-dimensional plane. Meanwhile, vehicles such as wheelchairs, bicycles, scooters, and automobiles include holonomic constraints, such as the inability to move directly sideways. Furthermore, since the moving speeds of pedestrians differ depending on whether they are adults, children, or elderly people, it is desirable to take into account the characteristics of more detailed classifications of pedestrians.

Similarly to the object identification unit A004, the non-controlled object position calculation unit A005 calculates the positions of non-controlled objects existing around the controlled object from the environmental information acquired by the environment recognizer A001 using the well-known Semantic SLAM technique. The object identification section A004 and the non-controlled object position calculation unit A005 can execute processing simultaneously using the same technology. In other words, the identification process by the object identification unit A004 and the position calculation process by the non-controlled object position calculation unit A005 can be performed in parallel.

FIG. 3 is a functional block diagram of the trajectory deviation evaluation unit A006. The trajectory deviation evaluation unit A006 includes a predicted trajectory calculation unit A006a, an actual trajectory evaluation unit A006b, and a trajectory comparison unit A006c.

The trajectory deviation evaluation unit A006 evaluates the degree of deviation of the actual movement trajectory (hereinafter also referred to as actual trajectory) of a non-controlled object from the predicted movement trajectory of the non-controlled object corresponding to the attribute of the non-controlled object. The predicted trajectory calculation unit A006a calculates the predicted movement trajectory of the non-controlled object on the basis of the attribute of the non-controlled object identified by the object identification unit A004 and the position of the non-controlled object calculated a predetermined time ago by the non-controlled object position calculation unit A005. For example, if the non-controlled object is a pedestrian, the position of the non-controlled object several seconds after the current position is calculated according to the equations of motion in Equations (3a) and (3b) described later. Furthermore, if the non-controlled object is a vehicle, the position of the non-controlled object several seconds after the current position is calculated according to the equations of motion in Equations (2a) and (2b) described later. The actual trajectory evaluation unit A006b evaluates the change in the position of the non-controlled object calculated by the non-controlled object position calculation unit A005 as the actual movement trajectory of the non-controlled object. The trajectory comparison unit A006c compares the predicted movement trajectory of the non-controlled object calculated by the predicted trajectory calculation unit A006a with the movement trajectory (actual trajectory) of the non-controlled object evaluated by the actual trajectory evaluation unit A006b, and evaluates the degree of deviation of the movement trajectory (actual trajectory) from the predicted movement trajectory.

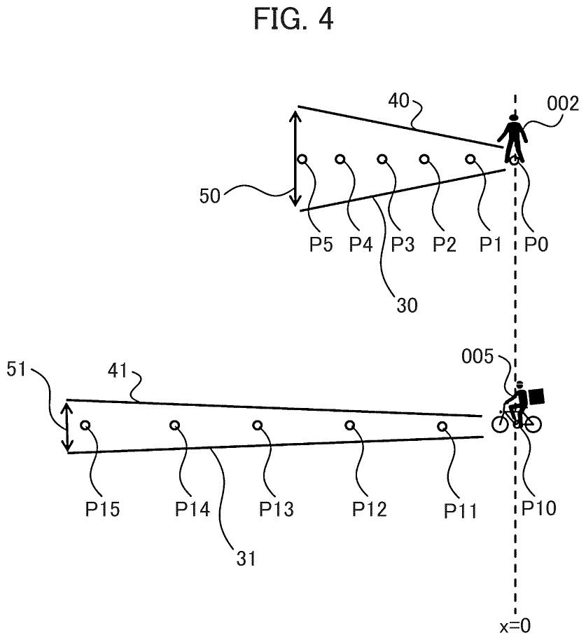

FIG. 4 is a schematic diagram showing an example of the predicted movement trajectory calculated by the predicted trajectory calculation unit A006a. FIG. 4 schematically shows predicted movement trajectories (hereinafter also simply referred to as predicted trajectories) calculated by the predicted trajectory calculation unit A006a for the pedestrian 002 and a bicycle 005.

When the pedestrian 002 is facing leftward on the paper at position P0 at time t0, the predicted trajectory calculation unit A006a predicts the position of the pedestrian 002 to be position P1 at time t1 after one step, position P2 at time t2 after two steps, position P3 at time t3 after three steps, position P4 at time t4 after four steps, and position P5 at time t5 after five steps. The predicted trajectory calculation unit A006a calculates the predicted trajectory shown in FIG. 4 by prediction based on a probability model. That is, the predicted trajectory calculation unit A006a calculates the average value and variance of the trajectory of the non-controlled object, and uses the result as the predicted movement trajectory. The positions P1 to P5 shown in FIG. 4 represent the average values of the predicted movement trajectory, and an upper limit 40 and a lower limit 30 shown in the figure are defined by a variance 50 of the predicted movement trajectory. As shown in FIG. 4, the predicted movement trajectory has a constant spread defined by the variance 50. In general, pedestrians can move freely not only straight but also diagonally and laterally, and therefore are characterized in that the candidate range of trajectories becomes wider as time progresses.

When the bicycle 005 is facing leftward on the paper at position P10 at time t0, the predicted trajectory calculation unit A006a predicts the position of the bicycle 005 to be position P11 at time t1 after one step, position P12 at time t2 after two steps, position P13 at time t3 after three steps, position P14 at time t4 after four steps, and position P15 at time t5 after five steps. Since the bicycle 005 is more difficult to move in the left-right direction than the pedestrian 002, the candidate range defined by an upper limit 41 and a lower limit 31 in the vertical direction on the paper does not extend as far as that of pedestrian 002. In other words, a variance 51 of the predicted trajectory of the bicycle 005 is smaller than the variance 50 of the predicted trajectory of the pedestrian 002. Meanwhile, the bicycle 005 moves faster than the pedestrian 002, and therefore is characterized in that the candidate range extends in the left-right direction on the paper. That is, the interval between the positions P10 to P15 of the bicycle 005 is wider than the interval between the positions P0 to P5 of the pedestrian 002.

The actual trajectory evaluation unit A006b shown in FIG. 3 evaluates the actual movement trajectory (actual trajectory) of the non-controlled object by recording the position of the non-controlled object calculated by the non-controlled object position calculation unit A005 for a predetermined period of time.

The trajectory comparison unit A006c compares the predicted trajectory calculated by the predicted trajectory calculation unit A006a with the actual trajectory evaluated by the actual trajectory evaluation unit A006b, and evaluates the behavior index (behavioral orientation) of the non-controlled object. The trajectory comparison unit A006c calculates the evaluation value using the following Equation (1). In Equation (1), k represents the time of the predicted trajectory, z(k) represents the coordinate of the predicted trajectory at time k, x(k) represents the coordinate of the actual trajectory at time k, and e(k) represents the trajectory deviation that is the difference between the predicted trajectory and actual trajectory at time k. The trajectory comparison unit A006c uses a trajectory deviation e calculated by Equation (1) as an evaluation value representing the degree of deviation of the actual trajectory from the predicted trajectory.

$$e ( k ) = ‖ x ( k ) - z ( k ) ‖ \qquad [ Equation 1 ]$$

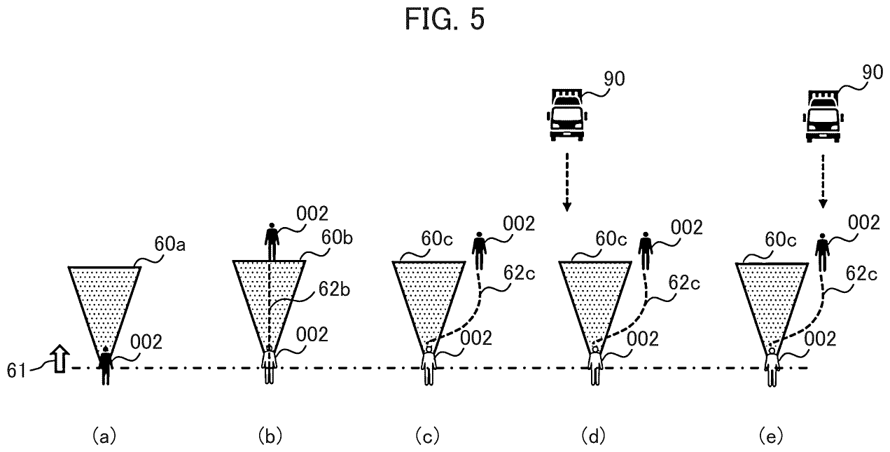

FIG. 5 is a schematic diagram showing examples of a predicted trajectory and an actual trajectory. FIG. 5(a) shows a candidate range 60a of the predicted trajectory of the pedestrian 002 (that is, non-controlled object) calculated by the predicted trajectory calculation unit A006a at a certain time. This example assumes a situation in which the pedestrian 002 moves upward (in the direction indicated by arrow 61) on the paper.

FIG. 5(b) shows an example of an actual trajectory 62b of the pedestrian 002 superimposed on a candidate range 60b of the predicted trajectory of the pedestrian 002. The actual trajectory 62b of the pedestrian 002 coincides with the center (average) of the candidate range 60b of the predicted trajectory. In other words, it can be determined that the behavior of the pedestrian 002 is easy to predict.

FIG. 5(c) shows an example of an actual trajectory 62c of the pedestrian 002 superimposed on a candidate range 60c of the predicted trajectory of the pedestrian 002. The actual trajectory 62c deviates from the candidate range 60c of the predicted trajectory. Such behavior of the pedestrian 002 may occur, for example, when the pedestrian 002 is drunk, so it can be said that the behavior of the pedestrian 002 is difficult to predict.

The safety level determination unit A007 shown in FIG. 3 determines a safety level for the behavior of the controlled object on the basis of the attribute of the non-controlled object identified by the object identification unit A004 and the degree of deviation from the predicted movement trajectory (trajectory deviation e) evaluated by the trajectory deviation evaluation unit A006. The safety level determination unit A007 uses two types of safety levels: “standard” which is the standard level of safety, and “safest” which is the highest level of safety. These safety levels each affect the motion control of the controlled object by the vehicle motion computation unit A008 (see FIG. 1). Although details will be described later, when the safety level is determined to be “safest”, the vehicle motion computation unit A008 performs motion control with a larger margin of distance between the non-controlled object and the controlled object than when the safety level is determined to be “standard”. In addition, apart from these two types, intermediate safety levels, which are higher in safety than the “standard” and lower in safety than the “safest”, are continuously used.

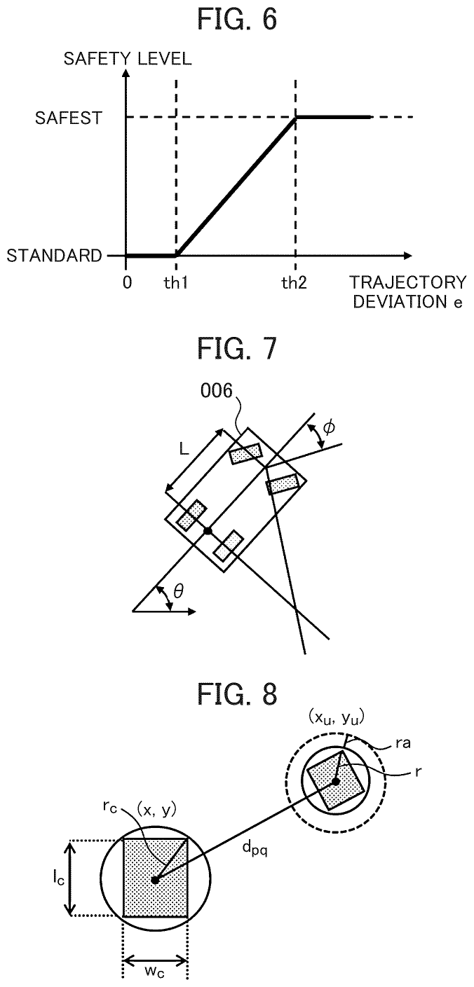

FIG. 6 illustrates a method for determining a safety level by the safety level determination unit A007. The safety level determination unit A007 changes the control content so that the greater the trajectory deviation e calculated by the trajectory comparison unit A006c, the safer the motion control of the controlled object is performed. In FIG. 6, the safety level is determined as “standard” when the trajectory deviation e is equal to or smaller than a threshold value th1, and the safety level is determined as “safest” when the trajectory deviation e is equal to or greater than a threshold value th2. Note that the threshold value th2 is greater than the threshold value th1. These threshold values th1 and th2 are desirably designed according to the variance of the predicted trajectory calculated by the predicted trajectory calculation unit A006a. For example, by using a standard deviation σ, which is the square root of the variance, it is easy to determine how likely the trajectory deviation e is to be occur relative to the prediction. In other words, if th1 is σ, control can be designed to respond to a situation where there is a deviation from the trajectory that should have a match of approximately 68%, and if th2 is 2σ, control can be designed to respond to a situation where there is a deviation from the trajectory that should have a match of approximately 95%.

Note that in FIG. 6, the safety level is continuously configured by providing two threshold values such as th1 and th2, but the safety level is not limited to this form. For example, only one threshold value may be set and the safety level may be determined as “standard” when the trajectory deviation e is less than the threshold value, and the safety level may be determined as “safest” when the trajectory deviation e is equal to or greater than the threshold value.

As described above, the controller A101 according to the present embodiment shown in FIG. 1 compares the predicted trajectory with the actual trajectory by calculating the predicted trajectory after detecting a non-controlled object (mobile object, pedestrian) before a predetermined time (predetermined step), and then obtaining the actual trajectory as the movement record for the predetermined time (predetermined step). In other words, it must be noted that the timing at which the non-controlled object (mobile object, pedestrian) is detected is different from the timing at which control becomes possible. When placing emphasis on safety, the controller A101 desirably sets the trajectory deviation e to an initial value equal to or higher than the threshold value th2 upon detecting a non-controlled object (mobile object, pedestrian), and changes the trajectory deviation e from the initial value when the actual trajectory deviation e can be calculated.

The vehicle motion computation unit A008 controls the motion of the controlled object on the basis of the position of the controlled object calculated by the controlled object position calculation unit A003, the position of the non-controlled object calculated by the non-controlled object position calculation unit A005, and the safety level determined by the safety level determination unit A007.

If the controlled object is a semi-autonomous vehicle, the vehicle motion computation unit A008 instructs the actuator controller B001 to interfere with vehicle speed to decelerate or stop the vehicle when the safety level becomes higher than “standard”. The actuator controller B001 drives the actuator B002 connected to the brake according to this instruction. Meanwhile, if the safety level is “standard” or lower, there is no need to interfere with the driver's operations.

If the vehicle to be controlled is an autonomous vehicle, the vehicle motion computation unit A008 also uses control functions related to overall vehicle motion.

FIG. 7 is a schematic diagram illustrating motion control of a four-wheeled vehicle. If the controlled object is a four-wheeled vehicle 006 shown in FIG. 7, considering a vector p=[x y θ] that summarizes the coordinates (x, y) and azimuth angle θ of the position of the vehicle, the simplified dynamics can be given by the following Equations (2a) and (2b). The azimuth angle θ corresponds to the angle between the reference azimuth and the axis extending in the longitudinal direction of the vehicle. Note that in Equation (2a), L is the distance between the front wheels and rear wheels of the vehicle, as shown in FIG. 7. Further, control input uc in Equations (2a) and (2b) is vehicle speed v and steering angle φ.

$$\begin{matrix}[ Equation 2 ] & \\ \frac{dp}{dt} = \frac{d}{dt} [ \begin{matrix}x \\ y \\ θ\end{matrix} ] = [ \begin{matrix}v cos θ \\ v sin θ \\ \frac{v}{L} tan ϕ\end{matrix} ] = f ( p , {u}_{c} ) & ( 2 a )\end{matrix}$$

$${u}_{c} = [ \begin{matrix}v & {ϕ ]}^{T}\end{matrix} \qquad ( 2 b )$$

Meanwhile, if the non-controlled object is a pedestrian, considering a vector q=[xu yu] that summarizes the coordinates (xu, yu) of the pedestrian's position, the simplified dynamics of the non-controlled object can be given by the following Equation (3a) and (3b). Equations (3a) and (3b) are based on the premise that the non-controlled object is a pedestrian, and assume a model, the positional coordinates of which can freely move in both the x and y directions. Control input uu in Equations (3a) and (3b) is an x-direction component vx and y-direction component vy of the velocity v of the non-controlled object. Note that if the non-controlled object is a vehicle, equations of motion in the same format as Equations (2a) and (2b) are used.

$$\begin{matrix}[ Equation 3 ] & \\ \frac{dq}{dt} = \frac{d}{dt} [ \begin{matrix}{x}_{u} \\ {y}_{u}\end{matrix} ] = [ \begin{matrix}{v}_{x} \\ {v}_{y}\end{matrix} ] = g ( q , {u}_{u} ) & ( 3 a )\end{matrix}$$

$${u}_{u} = [ \begin{matrix}{v}_{x} & {{v}_{y} ]}^{T}\end{matrix} \qquad ( 3 b )$$

The differential equations in the above Equations (2a) and (2b) and Equations (3a) and (3b) can be discretized as in the following Equations (4a) and (4b), respectively, using a sampling period Δt. Here, p(k) is the state vector of the controlled object at time k (computation step k), and p(k+1) is the state vector of the controlled object at the next time k+1 (next computation step k+1). Similarly, q(k) is the state vector of the non-controlled object (pedestrian) at time k (computation step k), and q(k+1) is the state vector of the non-controlled object (pedestrian) at the next time k+1 (next computation step k+1).

$$\begin{matrix}[ Equation 4 ] & \\ p ( k + 1 ) = p ( k ) + Δ t \cdot f ( p ( k ) , {u}_{c} ( k ) ) & ( 4 a )\end{matrix}$$

$$q ( k + 1 ) = q ( k ) + Δ t \cdot g ( q ( k ) , {u}_{u} ( k ) ) \qquad ( 4 b )$$

First, the content of control by the vehicle motion computation unit A008 when the safety level is “standard”, that is, when the non-controlled object follows the range of the predicted trajectory, will be explained. The movement of the controlled object can be predicted according to the above Equation (4a). Furthermore, the movement of the non-controlled object can be predicted according to the above Equation (4b). It is assumed that the position (xu, yu) and velocity (vx, vy) of the non-controlled object at the current time k0 can be used by the environment recognizer A001 and the non-controlled object position calculation unit A005. At this time, the variance of the position of the non-controlled object changes according to the following Equation (5). Here, P is the variance matrix of the position of the uncontrolled object and Qw is the variance of the process noise.

$$\begin{matrix}[ Equation 5 ] & \\ P ( k + 1 ) = P ( k ) + Qw ( k ) & ( 5 )\end{matrix}$$

It is also assumed that the rough size of the non-controlled object has been acquired by the environment recognizer A001, and that the non-controlled object can be surrounded by a circle with a radius r. If the size (radius r) of the non-controlled object cannot be acquired, the object identification unit A004 may set the radius r according to the attribute (pedestrian, bicycle, or the like) of the identified non-controlled object. For example, the object identification unit A004 sets the radius r to 1.5 meters when the attribute of the non-controlled object is a pedestrian, and sets the radius r to 2 meters when the attribute of the non-controlled object is a bicycle.

Meanwhile, when lc is the total length of the controlled object and wc is the total width, the controlled object can be surrounded by a circle with a radius rc shown in the following Equation (6).

$$\begin{matrix}[ Equation 6 ] & \\ {r}_{c} = \sqrt{{( {w}_{c} / 2 )}^{2} + {( {l}_{c} / 2 )}^{2}} & ( 6 )\end{matrix}$$

FIG. 8 is a schematic diagram showing the positional relationship between the controlled object and the non-controlled object. From the above assumptions, it can be said that the non-controlled object and the controlled object do not come into contact with each other as long as the positional relationship shown in FIG. 8 is satisfied, that is, the following Equations (7a), (7b), and (7c) are satisfied. Note that dpq in Equations (7a) and (7b) corresponds to the length of the line segment connecting the center of the controlled object and the center of the non-controlled object, that is, the distance between the controlled object and the non-controlled object. Moreover, ra in Equation (7c) is an incremental radius that takes into account the uncertainty of the predicted trajectory of the non-controlled object, and corresponds to the standard deviation calculated from the dispersion matrix P of the position of the non-controlled object. α is an adjustment parameter (greater than 0). For example, if α=2, the design is such that there is no contact with a 95% probability under the assumption that the predicted trajectory is correct.

$$\begin{matrix}[ Equation 7 ] & \\ {d}_{pq} > {r}_{c} + r + {r}_{a} & ( 7 a )\end{matrix}$$

$${d}_{pq} = \sqrt{{( p - q )}^{T} ( p - q )} \qquad ( 7 b )$$

$$p = [ \begin{matrix}x \\ y\end{matrix} ] , q = [ \begin{matrix}{x}_{u} \\ {y}_{u}\end{matrix} ]$$

$${r}_{a} = α ( {P}_{xx} ( k ) + {P}_{yy} ( k ) 〉 \qquad ( 7 c )$$

The controlled object can be autonomously controlled by performing control so that the position of the vehicle follows the target trajectory pr=[xr yr θr]. For example, in the case of a vehicle traveling on a general public road, the target trajectory can be set at the center of the road several meters ahead from the current vehicle position.

It is suitable to use the idea of model predictive control for such follow-up control. In other words, model predictive control can be formulated as a control problem for determining the control input uc so that an evaluation function J in the following Equation (8) is minimized under the constraint condition that the constraint conditions (7a), (7b), and (7c) are satisfied. Note that Q and R are weight matrices, and Np is a prediction step. Since the above is a formulation of general model predictive control, detailed explanation will be omitted.

$$\begin{matrix}[ Equation 8 ] & \\ J = {\sum }_{k = {k}_{0}}^{Np - {k}_{0} + 1} {( p ( k ) - r ( k ) )}^{T} Q ( p ( k ) - r ( k ) ) + {u}_{c}^{T} ( k ) {Ru}_{c} ( k ) & ( 8 )\end{matrix}$$

Next, the content of control by the vehicle motion computation unit A008 when the safety level is lower than “standard”, that is, when the non-controlled object deviates from the predicted trajectory but is on a safe trajectory, will be explained.

In such a situation, it becomes possible to maintain safety even if the vehicle being controlled increases its moving speed. Therefore, by increasing weight Q in the evaluation function (formula (8)) used for model predictive control, the followability of the controlled vehicle to the target trajectory can be increased. Alternatively, weight R may be reduced to allow the generation of a larger control input uc.

Note that when the safety level is lower than “standard”, the control content may be the same as when the safety level is “standard”.

Next, the content of control by the vehicle motion computation unit A008 when the safety level is higher than “standard”, that is, when the non-controlled object deviates from the predicted trajectory and is on a dangerous trajectory, will be explained.

Although the behavior of the non-controlled object cannot be predicted, it is assumed that its dynamics follow Equation (4b). Furthermore, it is assumed that the attribute of the non-controlled object (pedestrian, bicycle, or the like) has been identified by the object identification unit A004. The vehicle motion computation unit A008 sets the maximum moving speed of the non-controlled object according to this attribute. For example, if the non-controlled object belongs to a pedestrian, the maximum moving speed is set to 5 kilometers per hour, and if the non-controlled object belongs to a bicycle, the maximum moving speed is set to 20 kilometers per hour. Note that if the attribute of the non-controlled object cannot be identified, the vehicle motion computation unit A008 sets the maximum moving speed to the upper limit value according to the location where the non-controlled object exists. For example, if the non-controlled object is on a sidewalk, the maximum moving speed is set to 20 kilometers per hour, which is equivalent to a bicycle. Furthermore, if the non-controlled object is on a roadway, the maximum moving speed is set to 60 kilometers per hour, which is equivalent to a general vehicle.

When the safety level is higher than the standard, consider model predictive control that calculates not only the control input u of the controlled object but also the control input uu of the non-controlled object. However, since the non-controlled object cannot be controlled, the control input uu of the non-controlled object calculated by model predictive control is not actually used.

When the safety level is higher than the standard, the following Equation (9a) is given as an example of the evaluation function handled by model predictive control. An evaluation function J′ in Equation (9a) is obtained by adding an evaluation function Jp expressed in Equation (9b) to the evaluation function J expressed in Equation (8). Here, Qu and Ru are weight matrices.

$$\begin{matrix}[ Equation 9 ] & \\ {J}^{′} = J + {J}_{p} & ( 9 a )\end{matrix}$$

$${J}_{p} = {\sum }_{k = {k}_{0}}^{Np - {k}_{0} + 1} {Q}_{u} {d}_{p q} ( k ) {d}_{p q} ( k ) - {v}^{T} ( k ) {R}_{u} v ( k ) \qquad ( 9 b )$$

The effect obtained by giving the above Equation (9b) will be explained. First, the first term in Equation (9b) is the product of the distance dpq between the controlled object and the non-controlled object multiplied by the weight matrix Qu. In other words, minimizing the evaluation function Jp means minimizing the distance dpq between the controlled object and the non-controlled object. And the second term is the product of the control input uu of the non-controlled object (velocity v of the non-controlled object) multiplied by the weight matrix Ru, and this value is further multiplied by −1 to make the value negative. In other words, minimizing the evaluation function Jp means maximizing the control input uu of the non-controlled object (velocity v of the non-controlled object). Combining the above effects, the newly added evaluation function Jp becomes a problem design assuming that the non-controlled object approaches the controlled object at the fastest speed. Under such a problem design, by calculating the control input uc of the controlled object considering the constraint conditions of Equations (7a), (7b), and (7c), it is possible to generate commands to execute safe motion to avoid risky behavior of the non-controlled object while taking into account the possibility of such behavior.

Note that as mentioned above, this control operation is also adopted when a comparison between the predicted trajectory and the actual trajectory cannot be made immediately after the non-controlled object is detected. However, if the detection range of the environment recognizer A001 is sufficiently wide, the controlled object and the non-controlled object are sufficiently far apart, so even if Equation (9b) is taken into account, behavior that deviates from the constraint conditions (7a), (7b), (7c) is unlikely to occur. In other words, if the safety level is “standard”, a behavior similar to the case using Equation (8) is often generated.

Note that when the safety level determination unit A007 discretely determines the safety level using only one threshold value, the vehicle motion computation unit A008 only needs to switch between model predictive control that minimizes the evaluation function J expressed by Equation (8) and model predictive control that minimizes the evaluation function J′ expressed by Equation (9a). Further, as shown in FIG. 6, when the safety level determination unit A007 gradually raises the safety level from a situation where the trajectory deviation e exceeds the threshold th1, the vehicle motion computation unit A008 only needs to use model predictive control that minimizes the evaluation function J′ expressed by the following Equation (10) that utilizes an adjustment variable β (0≤3≤1). In other words, if the trajectory deviation e is equal to or smaller than the threshold value th1, by setting β=0, Equation (10) matches Equation (8). Meanwhile, if the trajectory deviation e is equal to or greater than the threshold value th2, by setting β=1, Equation (10) matches Equation (9a). Furthermore, if the trajectory deviation e is greater than the threshold value th1 and less than the threshold value th2, an intermediate behavior between Equation (8) and Equation (9a) is achieved by increasing the adjustment variable β as the trajectory deviation e becomes larger.

$$\begin{matrix}[ Equation 10 ] & \\ {J}^{′} = J + β {J}_{p} & ( 10 )\end{matrix}$$

The actuator controller B001 of the motion control system B100 controls the actuator B002 to achieve the calculated control input uc, that is, the vehicle speed v and the steering angle φ, and changes the accelerator opening and steering.

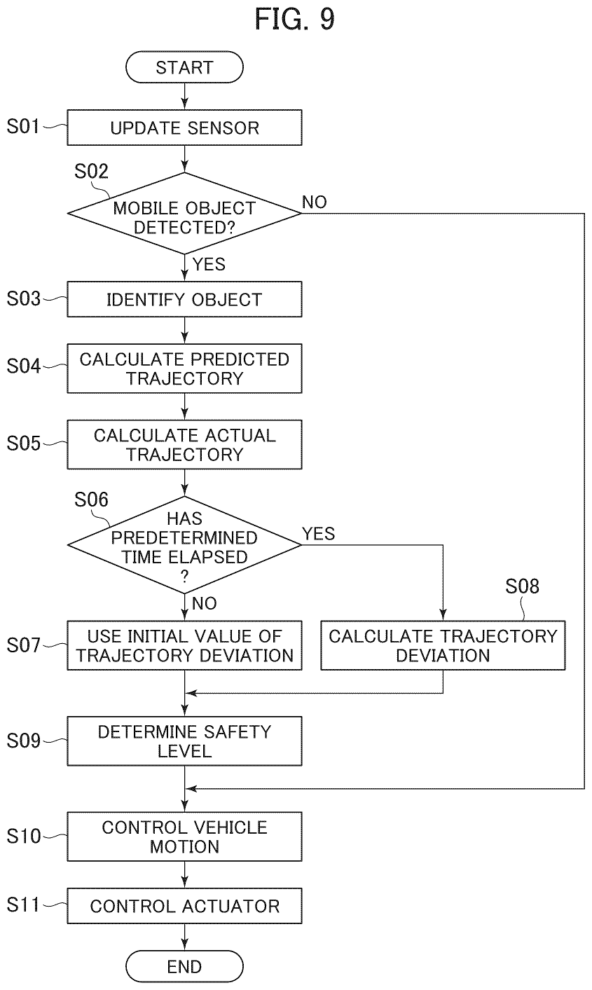

FIG. 9 is a flowchart showing an example of the flow of processing executed by the controller A101 of the autonomous control system. The processing shown in FIG. 9 is repeatedly executed at a predetermined control cycle. As shown in FIG. 9, in step S01, the controller A101 acquires detected values from the environment recognizer A001 and the state detector A002, and updates the detected values stored in the memory. In step S02, the controller A101 determines whether or not a mobile object, which is a non-controlled object, has been detected by the environment recognizer A001. If a non-controlled object is detected by the environment recognizer A001, the processing proceeds to step S03. Meanwhile, if a non-controlled object is not detected by the environment recognizer A001, the processing proceeds to step S10. In this case, the vehicle motion computation unit A008 performs control operation considering only the controlled object. That is, model predictive control is performed so as to minimize Equation (8) without considering constraint conditions (7a), (7b), and (7c).

In step S03, the object identification unit A004 identifies the non-controlled object on the basis of the environmental information acquired from the environment recognizer A001. The object identification unit A004 determines the moving speed limit (maximum value of control input uu) of the non-controlled object and the size (radius r) of the non-controlled object according to the identification result. In step S04, the predicted trajectory calculation unit A006a calculates the predicted trajectory of the non-controlled object according to the attribute of the non-controlled object identified in step S03.

In step S05, the actual trajectory evaluation unit A006b calculates the movement trajectory (actual trajectory) actually taken by the non-controlled object. In step S06, the trajectory comparison unit A006c determines whether a predetermined time has elapsed since the time when the non-controlled object was detected in step S02. If the actual trajectory is too short, the predicted trajectory and the actual trajectory cannot be compared, so such a determination is made in step S05. If the predetermined time has not elapsed, the processing proceeds to step S07. Meanwhile, if the predetermined time has elapsed, the processing proceeds to step S08.

If the processing proceeds to step S07, the actual trajectory is too short to compare the predicted trajectory and the actual trajectory, so the trajectory comparison unit A006c sets the trajectory deviation e to a predetermined initial value (a value equal to or greater than the threshold value th2). If the processing proceeds to step S08, the trajectory comparison unit A006c compares the predicted trajectory and the actual trajectory to calculate the trajectory deviation e.

In step S09, the safety level determination unit A007 determines a safety level according to the trajectory deviation e set in step S07 or calculated in step S08, and determines a model predictive control method to be used. In step S10, the vehicle motion computation unit A008 calculates the control input uc of the controlled vehicle according to the model predictive control method determined in step S09. In step S11, the vehicle motion computation unit A008 gives a control instruction to the actuator controller B001 to achieve the control input uc calculated in step S10. The actuator controller B001 controls each actuator B002 according to this control instruction.

According to the embodiment described above, the following effects are achieved.

(1) The trajectory deviation evaluation unit A006 evaluates the degree of deviation of a movement trajectory of the non-controlled object from a predicted movement trajectory of the non-controlled object corresponding to the attribute of the non-controlled object. The safety level determination unit A007 determines a safety level for the behavior of the controlled object on the basis of the attribute of the non-controlled object and the degree of deviation from the predicted movement trajectory. The vehicle motion computation unit A008 (behavior correction unit) corrects the behavior of the controlled object such that the higher the safety level, the less the controlled object approaches the non-controlled object on the basis of the position of the controlled object, the position of the non-controlled object, and the safety level. Thus, the autonomous or semi-automatic vehicle can be driven efficiently and safely even if it is difficult to predict the behavior of surrounding mobile objects.

(2) The predicted trajectory calculation unit A006a calculates an average value and variance of the trajectory on the basis of the attribute of the non-controlled object and the position of the non-controlled object calculated a predetermined time ago, and sets the result as the predicted movement trajectory of the non-controlled object. The actual trajectory evaluation unit A006b evaluates a change in the position of the non-controlled object as the movement trajectory of the non-controlled object. The trajectory comparison unit A006c evaluates the degree of deviation of the movement trajectory of the non-controlled object from the predicted movement trajectory of the non-controlled object. Thus, it is possible to appropriately determine the range of the predicted movement trajectory according to the attribute of the non-controlled object.

(3) The predicted trajectory calculation unit A006a calculates the predicted trajectory of the non-controlled object on the basis of the attribute of the non-controlled object, using the equation of motion followed by the non-controlled object, the maximum moving speed of the non-controlled object, and the size of the non-controlled object. Thus, it is possible to accurately calculate the predicted trajectory according to the attribute of the non-controlled object.

### Second Embodiment

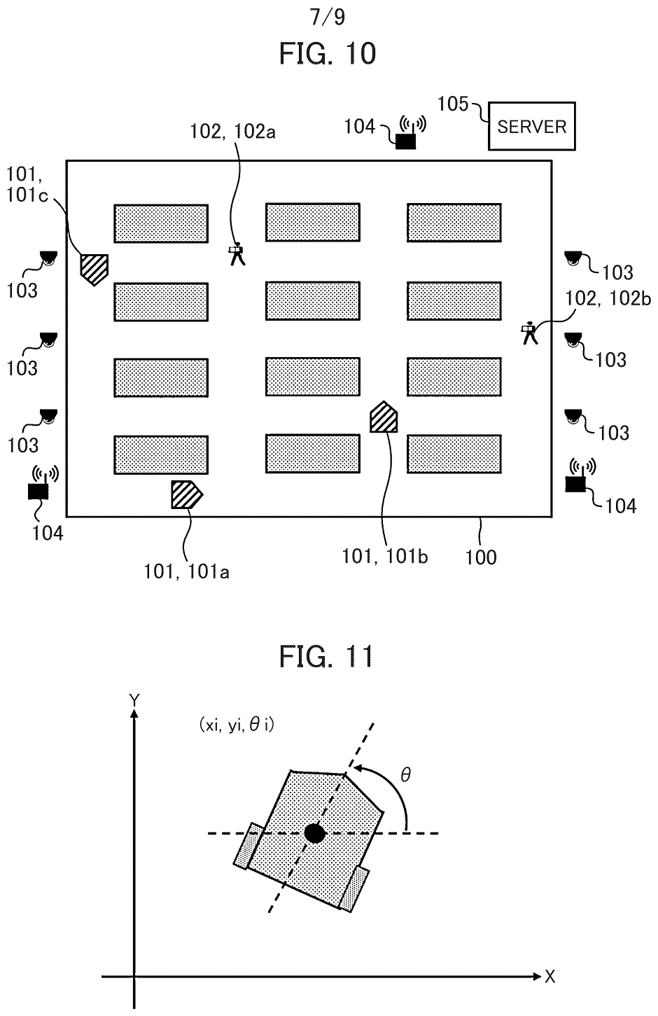

FIG. 10 is a schematic diagram showing a logistics warehouse to which an autonomous control system according to a second embodiment is applied. A total of three transport robots 101a, 101b, and 101c are arranged in a warehouse 100. The transport robots 101a, 101b, and 101c perform transport work together with workers. In the present embodiment, the transport robots 101a, 101b, and 101c are the controlled objects, and the pedestrians 102a and 102b, such as workers, are the non-controlled objects. In the following description, the transport robots 101a, 101b, and 101c are collectively referred to as the transport robot 101. Similarly, the pedestrians 102a and 102b are collectively referred to as the pedestrian 102.

A plurality of infrastructure sensors 103 are provided within the warehouse 100. The plurality of infrastructure sensors 103 monitor mobile objects present in the warehouse 100. Monitoring information from the plurality of infrastructure sensors 103 is sent to a server 105 via an access point 104 for wireless communication. The server 105 has the function of calculating a movement control plan for the transport robot 101 within the warehouse 100, and is responsible for the computation function of the autonomous control system according to the second embodiment. The server 105 includes hardware (processing device, volatile memory, nonvolatile memory, and the like) similar to the controller A101 described in the first embodiment. The server 105 and the transport robot 101 perform two-way communication. That is, the server 105 receives sensor information acquired by the transport robot 101, and the transport robot 101 receives a behavior plan from the server 105. The transport robot 101 is equipped with sensors such as a LiDAR sensor, an IMU, and an encoder, which correspond to the environment recognizer A001 and the state detector A002.

FIG. 11 is a schematic diagram illustrating the motion control of the transport robot 101. The transport robot 101 is driven by a differential two-wheel system. If the coordinates (xi, yi) and azimuth angle θi of the position of the transport robot 101 are given by a vector pi=[xi yi Oi], which summarizes the coordinates (xi, yi) and azimuth angle θi, using a subscript i corresponding to the ID assigned to each transport robot 101, the transport robot 101 follows the equation of motion of the following Equation (11). In Equation (11), vi is the speed of the transport robot 101, ωi is the angular velocity of the transport robot 101, and uc,i is the control input of the transport robot 101.

$$\begin{matrix}[ Equation 11 ] & \\ \frac{{dp}_{i}}{dt} = \frac{d}{dt} [ \begin{matrix}{x}_{i} \\ {y}_{i} \\ {θ}_{i}\end{matrix} ] = [ \begin{matrix}{v}_{i} cos {θ}_{i} \\ {v}_{i} sin {θ}_{i} \\ {ω}_{i}\end{matrix} ] = f ( {p}_{i} , {u}_{c , i} ) & ( 11 )\end{matrix}$$

The pedestrians 102 are also assigned IDs in the order in which the pedestrians 102 are recognized by the infrastructure sensor 103. If the coordinates ((xu, j), (yu, j)) of the position of the pedestrian 102 are given by a vector qj=[xu, j yu, j], which summarizes the coordinates ((xu, j), (yu, j)), using a subscript j corresponding to each ID, the pedestrian 102 follows the equation of motion of the following Equation (12). In Equation (12), vx, i is the x-direction component of the speed v of the pedestrian 102, vy, j is the y-direction component of the speed v of the pedestrian 102, and uu, j is the control input of the pedestrian 102.

$$\begin{matrix}[ Equation 12 ] & \\ \frac{{dq}_{j}}{dt} = \frac{d}{dt} [ \begin{matrix}{x}_{u , j} \\ {y}_{u , j}\end{matrix} ] = [ \begin{matrix}{v}_{x , j} \\ {v}_{y , j}\end{matrix} ] = g ( {q}_{j} , {u}_{u , j} ) & ( 12 )\end{matrix}$$

Similarly to the first embodiment described above, when the infrastructure sensor 103 corresponding to the environment recognizer A001 or the LiDAR sensor mounted in the transport robot 101 detects a non-controlled object (pedestrian), the object identification unit A004 identifies the attribute (movement characteristics) of the non-controlled object.

Unlike general public roads, in the case of limited areas such as logistics warehouses, the behaviors of robots and vehicles (including forklifts operated by humans) moving within the warehouse are managed by a warehouse management system (WMS) that operates the warehouse. Therefore, the attribute (movement characteristics) of the non-controlled object may be identified by linking the position of the non-controlled object detected by the controlled object to the operational situation of the vehicle managed by the WMS.

Similarly, in the case of limited areas such as logistics warehouse, most of the non-controlled objects that cannot be identified by attribute identification using the WMS described above are classified as pedestrians. However, even the same pedestrian classification can be further subdivided in a limited area.

For example, employees with long tenure are generally more familiar with warehouse operations and are less likely to engage in risky behavior. Similarly, part-time or casual workers who work for a limited period of time are less familiar with warehouse operations and are therefore more likely to engage in risky behavior. In addition, since the general public who come to tour the warehouse have never seen the transport robots 101, it is expected to behave even more dangerously.

It is difficult to infer the above classification from images and point cloud information acquired by the infrastructure sensor 103 or LiDAR sensor. However, in the case of a limited area, entry is not possible without an employee ID card or guest card, so the server 105 can acquire the attribute of the card holder by communicating with this card. The object identification unit A004 identifies the attribute of the pedestrian 102 on the basis of the attribute information received from the card held by the pedestrian 102 serving as a non-controlled object.

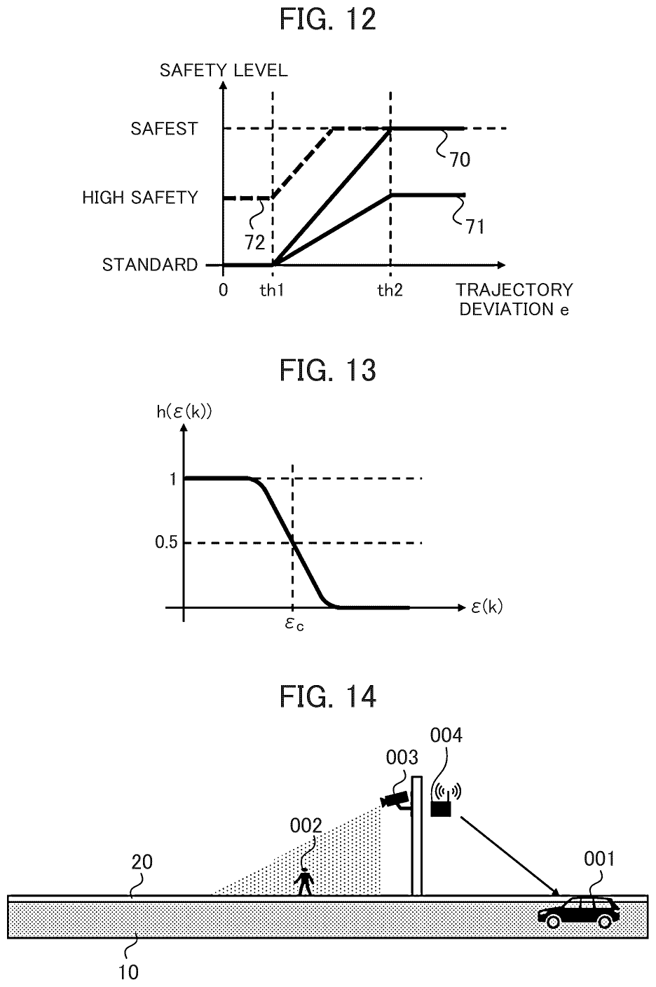

FIG. 12 illustrates a method for determining a safety level by the safety level determination unit A007 according to the second embodiment. In accordance the classification described above, the safety level determined by the safety level determination unit A007 can be subdivided as shown in FIG. 12. That is, even if the values of the trajectory deviation e between the predicted trajectory and the actual trajectory as calculated by the trajectory deviation evaluation unit A006 are the same, different safety levels are determined.

For example, the safety level determination unit A007 adopts a standard safety level characteristic 70, for the pedestrian 102 whose attribute is identified as a new employee, a part-time worker, or a casual worker by the object identification unit A004. The standard safety level characteristic 70 is similar to the characteristic shown in FIG. 6, so a description thereof will be omitted.

The safety level determination unit A007 adopts a safety level characteristic 71 for veterans, for the pedestrian 102 whose attribute is identified as an employee with long tenure by the object identification unit A004. Employees with long tenure have a higher level of safety awareness than new employees, part-timers, casual workers, and the like. Therefore, even if the safety level is not raised to “safest”, it can be expected that contact with the transport robot 101 will not occur. Therefore, the safety level characteristic 71 for veterans is a characteristic that sets the safety level to “high safety”, which is between “safest” and “standard”, when the trajectory deviation e is equal to or greater than the threshold value th2. The safety level characteristic 71 for veterans is a characteristic that increases the safety level as the trajectory deviation e increases in a range where the trajectory deviation e is greater than the threshold value th1 and less than the threshold value th2. The safety level characteristic 71 for veterans is a characteristic that sets the safety level to “standard” similarly to the safety level characteristic 70 for standard use when the trajectory deviation e is equal to or smaller than the threshold value th1.

The safety level determination unit A007 adopts a safety level characteristic 72 for guests, for the pedestrian 102 whose attribute is identified as a guest by the object identification unit A004. For guest card holders who may not be highly safety conscious, it is preferable to set the safety level higher than “standard” even if the predicted trajectory and the actual trajectory match. This makes it easier to avoid contact between the pedestrian (guest) 102 and the transport robot 101 even if the pedestrian (guest) 102 suddenly approaches the transport robot 101. The safety level characteristic 72 for guests is a characteristic that sets the safety level to “high safety”, which is between “standard” and “safest”, in a range where the trajectory deviation e is 0 or more and less than the threshold value th1. Furthermore, the safety level characteristic 72 for guests is a characteristic that increases the safety level as the trajectory deviation e increases if the trajectory deviation e is in the range greater than the threshold value th1 but less than the threshold value th2, and sets the safety level to “safest” if the trajectory deviation e is equal to or greater than an intermediate value between the threshold values th1 and th2.

Hereinafter, the control computation executed by the vehicle motion computation unit A008 when there are a plurality of controlled objects and a plurality of non-controlled objects will be explained.

First, the content of control by the vehicle motion computation unit A008 when the safety level determination unit A007 determines the safety level as “standard” will be explained. The conditions for preventing contact between the transport robot 101 and the pedestrian 102 are expressed by the following Equations (13a), (13b), (13c), and (13d).

A radius rc,i surrounding a transport robot 101(i) with ID i can be given by Equation (13a). Furthermore, a radius rj surrounding a pedestrian 102(j) whose ID is j is calculated according to the detection result of the environment recognizer A001. Further, an incremental radius ra,j that takes into account the uncertainty of the predicted trajectory of the pedestrian 102(j) can be given by Equation (13b). A distance dij between the transport robot 101(i) and the pedestrian 102(j) can be given by Equation (13c). Under the above preparations, the conditions for preventing contact between the transport robot 101(i) and the pedestrian 102(j) can be given by Equation (13d).

$$\begin{matrix}[ Equation 13 ] & \\ {r}_{c , i} = \sqrt{{( {w}_{c , i} / 2 )}^{2} + {( {l}_{c} , i / 2 )}^{2}} & ( 13 a )\end{matrix}$$

$${r}_{a , j} = α ( {P}_{xx , j} ( k ) + {P}_{yy , j} ( k ) ) \qquad ( 13 b )$$

$$\begin{matrix}{d}_{ij} = \sqrt{{( {p}_{i} - {q}_{j} )}^{T} ( {p}_{i} - {q}_{j} )} \\ {p}_{i} = [ \begin{matrix}{x}_{i} \\ {y}_{i}\end{matrix} ] , {q}_{j} = [ \begin{matrix}{x}_{u , j} \\ {y}_{u , j}\end{matrix} ]\end{matrix} \} \qquad ( 13 c )$$

$${d}_{ij} > {r}_{c , i} + {r}_{j} + {r}_{a , j} \qquad ( 13 d )$$

Note that if there are a plurality of transport robots 101 to be controlled, the conditions for preventing contact between the transport robots 101 are also required, but the method for calculating these conditions is similar to Equations (13a), (13b), (13c), and (13d), so the explanation will be omitted.

If a target route ri to be followed by the transport robot 101(i) is given, an evaluation function Ji to be considered for the transport robot 101(i) can be given by the following Equation (14), following Equation (8) when there is one controlled object.

$$\begin{matrix}[ Equation 14 ] & \\ {J}_{i} = {\sum }_{k = {k}_{0}}^{Np - {k}_{0} + 1} {( {r}_{i} ( k ) - {p}_{i} ( k ) )}^{T} {Q}_{i} ( {r}_{i} ( k ) - {p}_{i} ( k ) ) + {u}_{c , i}^{T} ( k ) {R}_{i} {u}_{c , i} ( k ) & ( 14 )\end{matrix}$$

To optimize the behavior of all the transport robots 101, the control input uc,i that minimizes the following Equation (15), which considers a sum J of the evaluation functions Ji of the transport robots 101, can be found by considering Equations (13a), (13b), (13c), and (13d), which are constraint conditions for preventing contact between the transport robot 101 and the pedestrian 102. In Equation (15), N is the number of the transport robots 101, and in the example shown in FIG. 10, N=3.

$$\begin{matrix}[ Equation 15 ] & \\ J = {\sum }_{i = 1}^{N} {J}_{i} = {\sum }_{i = 1}^{N} {\sum }_{k = {k}_{0}}^{Np - {k}_{0} + 1} {( {r}_{i} ( k ) - {p}_{i} ( k ) )}^{T} {Q}_{i} ( {r}_{i} ( k ) - {p}_{i} ( k ) ) + {u}_{c , i}^{T} ( k ) {R}_{i} {u}_{c , i} ( k ) & ( 15 )\end{matrix}$$

The server 105 distributes the calculated control input uc,i to each transport robot 101. The transport robot 101 drives the actuator B002 using the motion control system B100 provided in itself.

Next, the content of control by the vehicle motion computation unit A008 when the safety level determination unit A007 determines the safety level as “safest” will be explained. If there are a plurality of non-controlled objects, the evaluation function J′ to be considered can be given by the following Equations (16a) and (16b), following the Equations (9a) and (9b) when there is one non-controlled object. Here, M is the number of non-controlled objects, and in the example shown in FIG. 10, M=2. In Equation (16b), vj is the speed of the pedestrian 102 with ID j. Further, a function mj (ε(k)) included in Equation (16b) can be given by Equations (16c), (16d), (16e), and (16f). As in the problem establishment described above, the evaluation function J′ in Equation (16a) is obtained by adding the evaluation function Jp intended for the non-controlled object to approach the controlled object as quickly as possible, to the evaluation function J in Equation (15). However, if there are a plurality of controlled objects and non-controlled objects, the effect of improving safety cannot be sufficiently provided unless consideration is given to which controlled object to approach. In order to take this issue into account, Equation (16c) includes the function h(ε(k)) in Equation (16f). Note that in Equation (16c), W is a predetermined coefficient.

$$\begin{matrix}[ Equation 16 ] & \\ {J}^{′} = J = {\sum }_{j = 1}^{M} {J}_{p , j} & ( 16 a )\end{matrix}$$

$${J}_{p , j} = {\sum }_{k = {k}_{0}}^{Np - {k}_{0} + 1} {Q}_{u , j} {m}_{j} ( ϵ ( k ) ) - {v}_{j}^{T} ( k ) {R}_{u , j} {v}_{j} ( k ) \qquad ( 16 b )$$

$${m}_{j} ( ϵ ( k ) ) = W \sum {ϵ}_{ij}^{T} ( k ) {ϵ}_{ij} ( k ) \times h ( ϵ ( k ) ) \qquad ( 16 c )$$

$${ϵ}_{ij} ( k ) = {p}_{i} ( k ) - {q}_{j} ( k ) \qquad ( 16 d )$$

$$ϵ ( k ) = {ϵ}_{ij}^{T} ( k ) {ϵ}_{ij} ( k ) \qquad ( 16 e )$$

$$h ( ϵ ( k ) ) = \frac{1}{1 + exp ( ϵ ( k ) - {ϵ}_{c} )} \qquad ( 16 f )$$

FIG. 13 shows an example of the relationship between a function h(ε(k)) and a function ε(k). The function ε(k) calculated by Equations (16d) and (16e) corresponds to the square of the distance between the transport robot 101(i) with ID i and the pedestrian 102(j) with ID j. If the function ε(k) is large, that is, if the transport robot 101(i) and the pedestrian 102(j) are sufficiently far apart, Equation (16f) becomes 0. At this time, Equation (16c) also becomes 0. Meanwhile, if the function ε(k) is small, that is, if the transport robot 101(i) and the pedestrian 102(j) are close to each other, the function h(ε(k)) shown in Equation (16f) takes a value of 1. Only under these conditions, as in Equations (9a) and (9b), is the situation where the evaluation function Jp is added to the evaluation function J. In other words, the problem is to calculate the control input uc such that the transport robot 101(i) does not come into contact with the pedestrian 102(j) in a situation where the pedestrian 102(j) is approaching the nearby transport robot 101(i).

By using the control input uc calculated according to the model predictive control considering the evaluation functions in Equations (16a) and (16b) and the constraint conditions in Equations (13a), (13b), (13c), and (13d), it is possible to make the transport robot 101 behave more safely than when the safety level is “standard”.

According to the second embodiment described above, the following effects are achieved.

(1) The object identification unit A004 identifies the attribute of the non-controlled object using a card (device), which is provided on the non-controlled object and allows identification of the attribute of the non-controlled object. This makes it possible to determine the attribute of the non-controlled object in advance and use the attribute for motion control of the controlled object.

(2) Even for non-controlled objects having the same attribute identified by the object identification unit A004 and the same degree of deviation from the predicted movement trajectory as evaluated by the trajectory deviation evaluation unit A006, if evaluation values for safe behavior set on the cards (devices) that allow identification of the attributes of the non-controlled objects are different, the safety level determination unit A007 determines different safety levels. Thus, more flexible motion control can be performed using not only the attributes and behavior of the non-controlled objects but also the evaluation values of the non-controlled objects.

Although embodiments of the present invention have been described above in detail using examples of vehicles that travel on public roads and transport robots in logistics warehouses, it goes without saying that the scope of application of the present invention is not limited to these. For example, the present invention can be applied to transport vehicles at ports, robots moving in theme parks, and the like.

The following modifications are also within the scope of the present invention, and the configurations shown in the modifications may be combined with the configurations described in the above-described embodiments, the configurations described in the different embodiments described above may be combined, or the configurations described in the different modifications below may be combined.

### First Modification

FIG. 14 shows the configuration of an autonomous control system according to a first modification, and shows the vehicle 001 as a mobile object to be controlled and the pedestrian 002 as a mobile object that is not to be controlled. In the first embodiment, an example has been described in which the environment recognizer A001 is mounted in the controlled object. However, if surrounding information of the controlled object can be collected, the environment recognizer A001 does not need to be mounted in the controlled object. In the example shown in FIG. 14, an infrastructure sensor 003 serving as the environment recognizer A001 is installed at a location physically distant from the vehicle 001 to be controlled. The infrastructure sensor 003 provides the acquired sensor information of the pedestrian 002 to the vehicle 001 via the wireless system 004. Thus, the cost, weight, fuel consumption, and the like per vehicle can be reduced, for example, when a large number of vehicles are used in a limited space.

### Second Modification

In the example described in FIG. 6, the safety level is determined only by the trajectory deviation e. However, the safety level determination unit A007 is not limited to this form. For example, even in a case where the behavior of the pedestrian 002 such as shown in FIG. 5(c), where the trajectory deviation e is large, is observed, if the pedestrian 002 notices a vehicle 90 approaching from a distance and takes evasive action as shown in FIG. 5(d), then this pedestrian 002 is determined to be safety-conscious. Meanwhile, even in a situation similar to FIG. 5(d), if an actual trajectory is observed as shown in FIG. 5(e) where the pedestrian approaches the distant vehicle 90, this pedestrian is determined to be engaging in risky behavior.

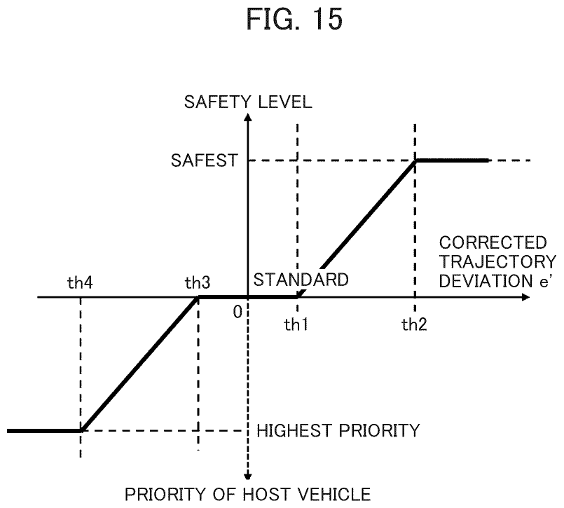

Therefore, the safety level may be determined using a corrected trajectory deviation e′ (see FIG. 15) with a negative sign when the non-controlled object moves away from the controlled object as shown in FIG. 5(d), and a positive sign when the non-controlled object approaches the controlled object as shown in FIG. 5(e). The trajectory deviation evaluation unit A006 calculates and maintains a predicted value of the distance (hereinafter also referred to as relative distance) between the controlled object and the non-controlled object after a predetermined period of time has elapsed, and compares the predicted value with the actual measured value of the relative distance when the above predetermined time actually elapses. If the actual measured value of the relative distance is greater than the predicted value, the trajectory deviation evaluation unit A006 determines that the non-controlled object is away from the controlled object. If the actual measured value of the relative distance is less than or equal to the predicted value, the trajectory deviation evaluation unit A006 determines that the non-controlled object is approaching the controlled object.

FIG. 15 illustrates a method for determining a safety level and the priority of the host vehicle by the safety level determination unit A007 according to a second modification. If the corrected trajectory deviation e′ is negative, that is, if the non-controlled object moves to avoid the controlled object, safety is not compromised even if the controlled object behaves selfishly. The vertical axis in FIG. 15 schematically shows that the safety level increases upward from the horizontal axis, and the priority of the host vehicle (controlled object) increases downward from the horizontal axis. FIG. 15 shows an example in which, if the corrected trajectory deviation e′ is negative, the safety level is maintained (maintaining β=0), but the priority of the host vehicle is increased as the absolute value of the corrected trajectory deviation e′ increases.

In the present modification, the evaluation function J′ is given by multiplying the first term on the right side of Equation (10) by a coefficient γ (J′=γJ+βJp). If the corrected trajectory deviation e′ is negative, the safety level determination unit A007 increases the coefficient y as the absolute value of the corrected trajectory deviation e′ increases, that is, as the priority of the host vehicle increases.

In the example shown in FIG. 15, if the corrected trajectory deviation e′ is negative and is equal to or less than 0 and equal to or greater than a threshold value th3, the priority is set to standard. Note that the priority is similarly set to standard if the corrected trajectory deviation e′ is 0 or more. In this case, the coefficient γ is set to 1. Note that the threshold value th3 is a value less than 0, for example, a value obtained by multiplying the threshold value th1 by −1. If the corrected trajectory deviation e′ is equal to or less than a threshold value th4, the priority is set to the highest priority. In this case, the coefficient γ is set to a predetermined value γ1, which is greater than 1. Note that the threshold value th4 is a value less than the threshold value th3, for example, a value obtained by multiplying the threshold value th2 by −1. If the corrected trajectory deviation e′ is less than the threshold value th3 and greater than the threshold value th4, the higher the absolute value of the corrected trajectory deviation e′, the higher the priority. In other words, the coefficient γ increases as the absolute value of the corrected trajectory deviation e′ increases.

If the coefficient γ is large, the speed of the controlled object can be increased, so the efficiency of work by the controlled object can be improved. For example, the application of such a control method to inter-process transport vehicles operating in a factory during peak season could contribute to improved productivity of the factory.

As described above, if the degree of deviation from the predicted trajectory evaluated by the trajectory deviation evaluation unit A006 is greater than a predetermined threshold (e>th1) and the behavior of the non-controlled object approaching the controlled object is observed, the safety level determination unit A007 according to the present modification changes the safety level for the behavior of the controlled object to the safer side (higher side) than the current level. Meanwhile, if the degree of deviation from the predicted trajectory evaluated by the trajectory deviation evaluation unit A006 is greater than a predetermined threshold (e>th1) and the behavior of the non-controlled object moving away from the controlled object is observed, the safety level determination unit A007 does not change the safety level to the higher side. In other words, according to the present modification, it is possible to determine accurate safety levels that take into account not only the attributes of non-controlled objects but also the behavior of non-controlled objects.

Note that the characteristics used to determine the safety levels and the priority of the host vehicle are not limited to the example shown in FIG. 15. For example, the characteristic used to determine the priority may be a characteristic that sets the priority to the highest priority when the corrected trajectory deviation e′ is equal to or less than the threshold value th3.

Although the embodiments of the present invention have been described above, the above embodiments merely show a part of the application examples of the present invention, and are not intended to limit the technical scope of the present invention to the specific configurations of the above embodiments.

Note that each configuration of the autonomous control system A100 described above, and the functions and execution processing of each of the configurations, may be partially or entirely implemented in hardware (for example, the logic for executing each function is designed using an integrated circuit). Furthermore, the control lines and information lines shown in the figures represent only those considered necessary for explanation, not necessarily representing all control lines and information lines required in terms of products. In practice, it may be considered that almost all configurations are interconnected.

### LIST OF REFERENCE SIGNS

A001 environment recognizer
A002 state detector
A003 controlled object position calculation unit
A004 object identification unit
A005 non-controlled object position calculation unit
A006 trajectory deviation evaluation unit
A006a predicted trajectory calculation unit
A006b actual trajectory evaluation unit
A006c trajectory comparison unit
A007 safety level determination unit
A008 vehicle motion computation unit
A100 autonomous control system
A101 controller
B001 actuator controller
B002 actuator
B100 motion control system

1. An autonomous control system that, in an area where a controlled object that is a behavior-controllable mobile object and a non-controlled object that is a behavior-uncontrollable mobile object are mixed, controls behavior of the controlled object so that the controlled object and the non-controlled object do not come into contact with each other, the autonomous control system comprising:
a controlled object position calculation unit that calculates a position of the controlled object;
an object identification unit that identifies an attribute of the non-controlled object;
a non-controlled object position calculation unit that calculates a position of the non-controlled object;
a trajectory deviation evaluation unit that evaluates a degree of deviation of a movement trajectory of the non-controlled object calculated by the non-controlled object position calculation unit from a predicted movement trajectory of the non-controlled object corresponding to the attribute of the non-controlled object identified by the object identification unit;
a safety level determination unit that determines a safety level for the behavior of the controlled object on a basis of the attribute of the non-controlled object identified by the object identification unit and the degree of deviation from the predicted movement trajectory evaluated by the trajectory deviation evaluation unit; and
a behavior correction unit that corrects the behavior of the controlled object such that the higher the safety level, the less the controlled object approaches the non-controlled object on the basis of the position of the controlled object calculated by the controlled object position calculation unit, the position of the non-controlled object calculated by the non-controlled object position calculation unit, and the safety level determined by the safety level determination unit.

2. The autonomous control system according to claim 1, wherein
the trajectory deviation evaluation unit includes:
a predicted trajectory calculation unit that calculates an average value and variance of a trajectory on the basis of the attribute of the non-controlled object identified by the object identification unit and the position of the non-controlled object calculated a predetermined time ago by the non-controlled object position calculation unit, and sets the result as the predicted movement trajectory of the non-controlled object;
an actual trajectory evaluation unit that evaluates a change in the position of the non-controlled object calculated by the non-controlled object position calculation unit, as the movement trajectory of the non-controlled object; and
a trajectory comparison unit that evaluates the degree of deviation of the movement trajectory of the non-controlled object evaluated by the actual trajectory evaluation unit from the predicted movement trajectory of the non-controlled object calculated by the predicted trajectory calculation unit.

3. The autonomous control system according to claim 2, wherein
the predicted trajectory calculation unit calculates the predicted movement trajectory of the non-controlled object on the basis of the attribute of the non-controlled object identified by the object identification unit, using an equation of motion followed by the non-controlled object, a maximum moving speed of the non-controlled object, and a size of the non-controlled object.

4. The autonomous control system according to claim 1, wherein
if the degree of deviation from the predicted movement trajectory evaluated by the trajectory deviation evaluation unit is greater than a predetermined threshold value, the safety level determination unit changes the safety level to a safer side than a current level, but if behavior of the non-controlled object moving away from the controlled object is observed, the safety level is not changed.

5. The autonomous control system according to claim 1, wherein
the object identification unit identifies the attribute of the non-controlled object using a device, the device being provided on the non-controlled object and allowing identification of the attribute of the non-controlled object.

6. The autonomous control system according to claim 5, wherein
even for non-controlled objects having the same attribute identified by the object identification unit and the same degree of deviation from the predicted movement trajectory as evaluated by the trajectory deviation evaluation unit, if evaluation values for safe behavior set on the devices that allow identification of the attributes of the non-controlled objects are different, the safety level determination unit determines different safety levels.
